(19) United States
(12) Patent Application Publication
(10) Pub. No.: US 2026/0046571 A1
(43) Pub. Date: Feb. 12, 2026

(54) AUDITORY DEVICE WITH VIBRATING EXTERNAL ACTUATOR COMPATIBLE WITH BILATERAL OPERATION

(71) Applicant: Cochlear Limited, Macquarie University, NSW (AU)

(72) Inventors: Henrik Fyrlund, Mölnlycke (SE); Amanda Djäknegren, Göteburg (SE); Frida Grothérus, Göteburg (SE)

(21) Appl. No.: 19/101,397

(22) PCT Filed: Aug. 21, 2023
(86) PCT No.: PCT/IB2023/058330

§ 371 Date: Feb. 5, 2025

Related U.S. Application Data
(60) Provisional application No. 63/374,636, filed on Sep. 6, 2022.

(51) Int. Cl. H04R 25/00; H04R 1/10

(52) U.S. Cl. CPC H04R 25/606; H04R 1/105; H04R 25/456; H04R 25/609; H04R 25/652; H04R 2201/109; H04R 2460/13

(57) ABSTRACT

An apparatus includes an elongate housing having a longitudinal axis and a perimeter. The housing is configured to be positioned on and substantially parallel to a skin surface of a recipient's body with the longitudinal axis and the perimeter extending along the skin surface. The perimeter extends a first maximum distance from the longitudinal axis in a first direction substantially perpendicular to the longitudinal axis, and the perimeter extends a second maximum distance from the longitudinal axis in a second direction opposite to the first direction. The second maximum distance is substantially equal to the first maximum distance. The apparatus further includes an actuator within the housing. The actuator is configured to generate vibrational signals and to transmit the vibrational signals to the recipient's body.

### BACKGROUND

### Field

The present application relates generally to systems and methods utilizing bone conduction transducers of an auditory system.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises an elongate housing having a longitudinal axis and a perimeter. The housing is configured to be positioned on and substantially parallel to a skin surface of a recipient's body with the longitudinal axis and the perimeter extending along the skin surface. The perimeter extends a first maximum distance from the longitudinal axis in a first direction substantially perpendicular to the longitudinal axis, and the perimeter extends a second maximum distance from the longitudinal axis in a second direction opposite to the first direction. The second maximum distance is substantially equal to the first maximum distance. The apparatus further comprises an actuator within the housing. The actuator is configured to generate vibrational signals and to transmit the vibrational signals to the recipient's body.

In another aspect disclosed herein, a method comprises placing an external device at a first side of a recipient's skull with a surface of the external device facing the recipient's skull. The method further comprises removing the external device from the first side of the recipient's skull. The method further comprises placing the external device at a second side of the recipient's skull with the surface of the external device facing the recipient's skull. The second side is substantially opposite to the first side.

In another aspect disclosed herein, an apparatus comprises a housing configured to be positioned between an ear and a skull of a recipient. The apparatus further comprises an actuator within the housing. The actuator is configured to generate vibrational signals and to transmit the vibrational signals to the skull. The apparatus further comprises an elongate signal conduit in operative communication with and extending from the housing. The apparatus further comprises a microphone in operative communication with a portion of the conduit spaced from the housing. The microphone is configured to be positioned within a recess of a pinna of the ear.

### BRIEF DESCRIPTION OF THE DRAWINGS

Implementations are described herein in conjunction with the accompanying drawings, in which:

FIG. 1 schematically illustrates an example transcutaneous bone conduction device in accordance with certain implementations described herein;

FIG. 2 schematically illustrates a portion of an example transcutaneous bone conduction device implanted in a recipient in accordance with certain implementations described herein;

FIGS. 3A and 3B schematically illustrate example apparatus in accordance with certain implementations described herein;

FIG. 4 schematically illustrates the example apparatus of FIG. 3B at an example position on the left ear of the recipient's body in accordance with certain implementations described herein;

FIG. 5 schematically illustrates an apparatus switched from being used at the right side of the recipient's skull to being used at the left side of the recipient's skull in accordance with certain implementations described herein; and

FIG. 6 is a flow diagram of an example method in accordance with certain implementations described herein.

### DETAILED DESCRIPTION

Certain implementations described herein provide an apparatus (e.g., bone conduction device or auditory prosthesis) comprising an actuator housing configured to be switched between equivalent positions on either the left side or the right side of the recipient's skull (e.g., behind a left ear of the recipient or behind a right ear of the recipient). In either position, the same outer housing surface is in mechanical communication with the recipient's skull behind the ear. The apparatus can further comprise an elongate signal conduit (e.g., wire; suspension hook) coupled to the housing and comprising a microphone spaced from the housing (e.g., within a recess of the pinna; in or in proximity to the ear canal). The elongate signal conduit can be configured to transmit signals from the microphone to circuitry within the housing and to facilitate the apparatus being worn over the recipient's ear with the pinna between the housing and the microphone. Placement of the microphone in or in proximity of the ear canal can facilitate directionality and more natural beamforming. Separation of the actuator and the microphone (e.g., with the pinna therebetween) can facilitate reduced acoustic feedback by screening vibrations generated by the actuator from being detected by the microphone.

The teachings detailed herein are applicable, in at least some implementations, to any type of implantable or non-implantable vibration stimulation system or device (e.g., implantable or non-implantable bone conduction auditory prosthesis device or system). Implementations can include any type of medical device that can utilize the teachings detailed herein and/or variations thereof. Furthermore, while certain implementations are described herein in the context of auditory prosthesis devices, certain other implementations are compatible in the context of other types of devices or systems (e.g., bone conduction headphones; bone conduction speakers; bone conduction microphones; ultrasonic imaging).

Merely for ease of description, apparatus and methods disclosed herein are primarily described with reference to an illustrative medical system, namely a bilateral active transcutaneous bone conduction auditory prosthesis system. However, the teachings detailed herein and/or variations thereof may also be used with a variety of other medical or non-medical systems that provide a wide range of therapeutic benefits to recipients, patients, or other users. In some implementations, the teachings detailed herein and/or variations thereof can be utilized in other types of devices beyond auditory prostheses that may benefit from improvement of hearing percepts at lower vibrational frequency ranges of vibrations generated by an electromagnetic transducer. Implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses. In some implementations, the teachings detailed herein and/or variations thereof can be utilized in other types of prostheses beyond auditory prostheses.

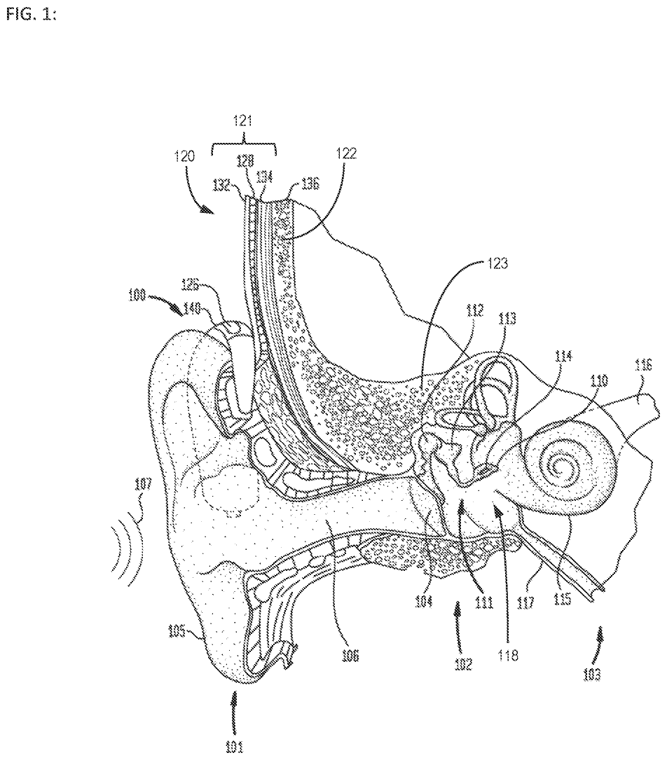

FIG. 1 schematically illustrates an example transcutaneous bone conduction device 100, as worn by a recipient, in accordance with certain implementations described herein. As shown, the recipient has an outer ear 101, a middle ear 102, and an inner ear 103. Elements of the outer ear 101, the middle ear 102, and the inner ear 103 are described herein, along with a description of the example bone conduction device 100.

In a fully functional ear, the outer ear 101 comprises a pinna 105 (e.g., auricle) and an ear canal 106. An acoustic pressure or sound wave 107 is collected by the pinna 105 and channeled into and through the ear canal 106. Disposed across the distal end of the ear canal 106 is a tympanic membrane 104 which vibrates in response to the sound wave 107. This vibration is coupled to the oval window or fenestra ovalis 110, which is adjacent to the round window 121, through the bones of the middle ear 102. The bones of the middle ear 102 comprise the malleus 112, the incus 113, and the stapes 114, collectively referred to as the ossicles 111. The ossicles 111 are positioned in the middle ear cavity 118 and serve to filter and amplify the sound wave 107, causing the oval window 110 to articulate (vibrate) in response to the vibration of tympanic membrane 104. This vibration of the oval window 110 sets up waves of fluid motion of the perilymph within the cochlea 139. Such fluid motion, in turn, activates tiny hair cells (not shown) inside of the cochlea 139. Activation of the hair cells causes appropriate nerve impulses to be generated and transferred through the spiral ganglion cells (not shown) and auditory nerve 116 to the brain (also not shown) where they are perceived as sound.

The human skull is formed from a number of different bones that support various anatomical features. Illustrated in FIG. 1 is the temporal bone 136 which is situated at the side and base of the recipient's skull 120 (covered by a portion of the recipient's skin 132, muscle 134, and fat 128, collectively referred to herein as tissue 121). For ease of reference, the temporal bone 136 is referred to herein as having a superior portion 122 and a mastoid portion 123. The superior portion 122 comprises the section of the temporal bone 136 that extends superior to the pinna 105. That is, the superior portion 122 is the section of the temporal bone 136 that forms the side surface of the skull 120. The mastoid portion 123, referred to herein simply as the mastoid 123, is positioned inferior to the superior portion 122. The mastoid 123 is the section of the temporal bone 136 that surrounds the middle ear 102.

FIG. 1 also illustrates the positioning of bone conduction device 100 relative to the outer ear 101, the middle ear 102, and the inner ear 103 of a recipient of the bone conduction device 100. As shown, the bone conduction device 100 is positioned behind the outer ear 101 of the recipient. The bone conduction device 100 can comprise an external component 140 in the form of a behind-the-ear (BTE) device.

The external component 140 typically comprises one or more sound input elements 126, such as a microphone, for detecting and capturing sound, a sound processing unit (not shown) and a power source (not shown). The microphone and sound processing unit can be referred to collectively as sound processing components. The external component 140 includes an actuator (not shown), which in the example implementation of FIG. 1, is located within the body of the BTE device. In certain other implementations, the actuator can be located remote from the BTE device (or from other external component 140 having a sound input element, a sound processing unit and/or a power source, etc.).

In certain implementations, the sound input element 126 can comprise devices other than a microphone, such as, for example, a telecoil, etc. In certain implementations, the sound input element 126 can be located remote from the BTE device and can take the form of a microphone or the like located on a cable or can take the form of a tube extending from the BTE device, etc. Alternatively, the sound input element 126 can be subcutaneously implanted in the recipient, or positioned in the recipient's ear. The sound input element 126 can also be a component that receives an electronic signal indicative of sound, such as, for example, from an external audio device. For example, the sound input element 126 can receive a sound signal in the form of an electrical signal from an MP3 player electronically connected to sound input element 126.

In certain implementations, the sound processing unit of the external component 140 processes the output of the sound input element 126, which is typically in the form of an electrical signal. The processing unit generates control signals that cause the actuator to vibrate. In other words, the actuator converts the electrical signals into mechanical vibrations for delivery to the recipient's skull.

As noted above, with respect to the example implementation of FIG. 1, the bone conduction device 100 is a passive transcutaneous bone conduction device. That is, no active components, such as the actuator, are implanted beneath the recipient's skin 132. In such an arrangement, the active actuator is located in the external component 140.

The example implementation of FIG. 1 is depicted as having no implantable component. That is, vibrations generated by the actuator are transferred from the actuator, into the skin 132 directly from the actuator and/or through a housing of the BTE device, through the skin 132 of the recipient, and into the bone of the recipient (e.g., temporal bone 136), thereby evoking a hearing percept without passing through an implantable component. In this regard, it is a totally external bone conduction device. Alternatively, other example implementations comprise an implantable component that includes a plate or other applicable component configured to vibrate in response to vibration or signals transmitted through the skin.

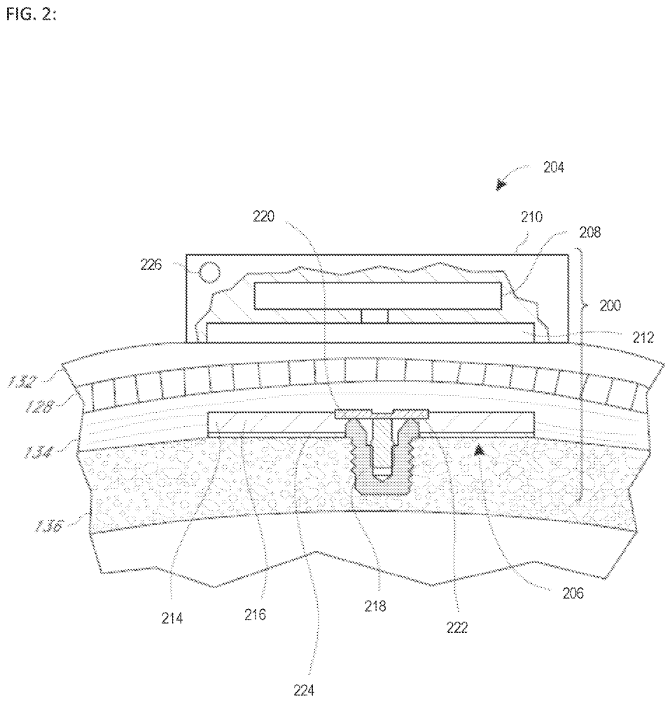

FIG. 2 schematically illustrates a portion of an example transcutaneous bone conduction device 200 implanted in a recipient in accordance with certain implementations described herein. The example transcutaneous bone conduction device 200 of FIG. 2 includes an external component 204 and an implantable component 206. The transcutaneous bone conduction device 200 of FIG. 2 is a passive transcutaneous bone conduction device in that a vibrating actuator 208 is located in the external component 204 and delivers vibrational stimuli through the skin 132 to the skull 120 (e.g., temporal bone 136). The vibrating actuator 208 is located in a housing 210 of the external component 204 and is coupled to a plate 212. The plate 212 can be in the form of a permanent magnet and/or in another form that generates and/or is reactive to a magnetic field, or otherwise permits the establishment of magnetic attraction between the external component 204 and the implantable component 206 sufficient to hold the external component 204 against the skin 132 of the recipient.

In certain implementations, the vibrating actuator 208 is a device that converts electrical signals into vibration. In operation, a sound input element 226 (e.g., external microphone) can convert sound into electrical signals. Specifically, the transcutaneous bone conduction device 200 can provide these electrical signals to the vibrating actuator 208, or to a sound processor (not shown) that processes the electrical signals, and then provides those processed signals to the vibrating actuator 208. The vibrating actuator 208 can convert the electrical signals (processed or unprocessed) into vibrations. Because the vibrating actuator 208 is mechanically coupled to the plate 212, the vibrations are transferred from the vibrating actuator 208 to the plate 212. The implanted plate assembly 214 is part of the implantable component 206 and is made of a ferromagnetic material that may be in the form of a permanent magnet, that generates and/or is reactive to a magnetic field, or otherwise permits the establishment of a magnetic attraction between the external component 204 and the implantable component 206 sufficient to hold the external component 204 against the skin 132 of the recipient. Accordingly, vibrations produced by the vibrating actuator 208 of the external component 204 are transferred from the plate 212 across the skin 132 to a plate 216 of the plate assembly 214. This can be accomplished as a result of mechanical conduction of the vibrations through the skin 132, resulting from the external component 204 being in direct contact with the skin 132 and/or from the magnetic field between the two plates 212, 216. These vibrations are transferred without a component penetrating the skin 132, fat 128, or muscular 134 layers on the head.

In certain implementations, the implanted plate assembly 214 is substantially rigidly attached to a bone fixture 218. The implantable plate assembly 214 can include a through hole 220 that is contoured to the outer contours of the bone fixture 218. This through hole 220 thus forms a bone fixture interface section that is contoured to the exposed section of the bone fixture 218. In certain implementations, the sections are sized and dimensioned such that at least a slip fit or an interference fit exists with respect to the sections. A screw 222 can be used to secure the plate assembly 214 to the bone fixture 218. In certain implementations, a silicone layer 224 is located between the plate 216 and the bone (e.g., temporal bone 136) of the skull 120.

As can be seen in FIG. 2, the head of the screw 222 is larger than the hole through the implantable plate assembly 214, and thus the screw 222 positively retains the implantable plate assembly 214 to the bone fixture 218. The portions of the screw 222 that interface with the bone fixture 218 substantially correspond to an abutment screw, thus permitting the screw 222 to readily fit into an existing bone fixture used in a percutaneous bone conduction device. In certain implementations, the screw 222 is configured so that the same tools and procedures that are used to install and/or remove an abutment screw from the bone fixture 218 can be used to install and/or remove the screw 222 from the bone fixture 218.

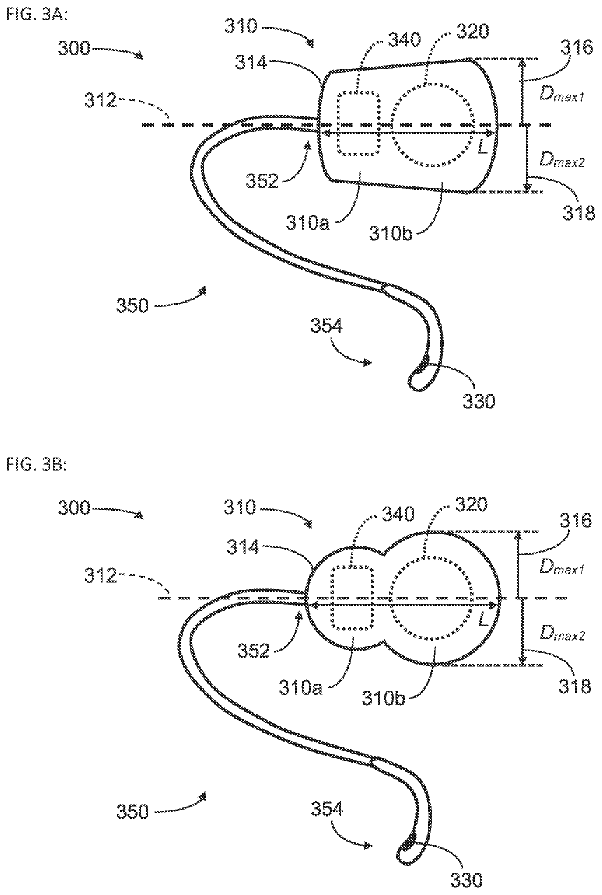

FIGS. 3A and 3B schematically illustrate example apparatus 300 in accordance with certain implementations described herein. The apparatus 300 comprises an elongate housing 310 having a longitudinal axis 312 and a perimeter 314. The housing 310 is configured to be positioned on and substantially parallel to a skin surface of a recipient's body with the longitudinal axis 312 and the perimeter 314 extending along the skin surface. The perimeter 314 extends a first maximum distance Dₘₐₓ₁ from the longitudinal axis 312 in a first direction 316 substantially perpendicular to the longitudinal axis 312. The perimeter 314 extends a second maximum distance Dₘₐₓ₂ from the longitudinal axis 312 in a second direction 318 opposite to the first direction 316. The second maximum distance Dₘₐₓ₂ is substantially equal to the first maximum distance Dₘₐₓ₁. In certain implementations, the longitudinal axis 312 is a symmetry axis of the housing 310 (e.g., the housing 310 has a mirror symmetry about the longitudinal axis 312). The actuator 320 is configured to generate vibrational signals and to transmit the vibrational signals to the recipient's body.

In certain implementations, the apparatus 300 (e.g., bone conduction device 100) is configured to be worn at a side of the recipient's skull 120, to generate auditory vibrations, and to provide the auditory vibrations (e.g., via the underlying tissue 121 and bone conduction through the temporal bone 136) to a corresponding ear (e.g., the ipsilateral ear) of the recipient. In certain other implementations, the apparatus 300 (e.g., external component 204 of bone conduction device 200) is configured to be worn over an implantable component 206 implanted at a side of the recipient's skull 120, to generate auditory vibrations of the plate 212 magnetically coupled to the plate 216, and to provide the auditory vibrations from the plate 216 (e.g., via bone conduction through the temporal bone 136) to a corresponding ear (e.g., the ipsilateral ear) of the recipient. As used herein, the phrase “auditory vibrations” has its broadest reasonable meaning, including vibrations within a range of vibrational frequencies that are perceptible by the recipient as sound (e.g., a range of 20 Hz to 20 kHz).

The apparatus 300 of certain implementations comprises an external component (e.g., external component 140, 204) of an auditory prosthesis system. The apparatus 300 can include a sound input element (e.g., a microphone; a cable or wireless connection configured to receive signals indicative of sound from an audiovisual device), a sound processor (e.g., sound processing circuitry, control electronics, actuator drive components, power module) configured to generate control signals in response to electrical signals from the sound input element, and the actuator 320 (e.g., vibrating actuator 208) configured to generate acoustic vibrations in response to the control signals.

In certain implementations, the apparatus 300 comprises a non-surgical device (e.g., see FIG. 1) which can be used without the recipient undergoing surgery (e.g., without a device being implanted within the recipient's tissue). In certain other implementations, the apparatus 300 comprises a surgical or semi-surgical device (see., e.g., FIG. 2) for which the user undergoes a surgical procedure (e.g., to implant a device within the recipient's tissue).

The housing 310 of certain implementations comprises at least one biocompatible material (e.g., plastic; PEEK; silicone; ceramic; zirconium oxide). In certain implementations, the housing 310 (e.g., housing 210) is configured to hermetically seal an inner region within the housing 310 from an environment surrounding the housing 310 (e.g., the inner region containing the sound processor and/or the actuator 320). For example, as schematically illustrated by FIGS. 3A and 3B, the housing 310 can comprise a first housing portion 310a comprising a power source (e.g., battery) and electronics (e.g., sound processor) and a second housing portion 310b comprising the actuator 320. In certain implementations, the second housing portion 310b is configured to hold the apparatus 300 in contact with the recipient's skin 132 such that vibrations from the actuator 320 are substantially transmitted to the recipient's body. For example, the second housing portion 310b can comprise a permanent magnet configured to generate an attractive magnetic force with an implanted component 206, the magnetic force sufficient to hold the apparatus 300 over the implanted component 206. For another example, the second housing portion 310b can comprise an adhesive configured to adhere the apparatus 300 onto the recipient's skin 132.

In certain implementations, the housing 310 is substantially planar and the longitudinal axis 312 is a symmetry axis of the perimeter 314. The housing 310 of certain implementations is configured to be worn on the outer surface of the recipient's skin 132 with the longitudinal axis 312 extending substantially parallel to the outer surface of the recipient's skin 132. The housing 310 can have a length L substantially along the longitudinal axis 312 that is less than or equal to 40 millimeters (e.g., in a range of 15 millimeters to 35 millimeters; in a range of 25 millimeters to 35 millimeters; in a range of less than 30 millimeters; in a range of 15 millimeters to 30 millimeters), a width W substantially perpendicular to the longitudinal axis 312 that is that is less than or equal to 40 millimeters (e.g., in a range of 15 millimeters to 35 millimeters; in a range of 25 millimeters to 35 millimeters; in a range of less than 30 millimeters; in a range of 15 millimeters to 30 millimeters), and/or a thickness less than or equal to 10 millimeters (e.g., in a range of less than or equal to 7 millimeters, in a range of less than or equal to 5 millimeters; in a range of less than or equal to 4 millimeters).

In certain implementations, the width of the housing 310 is substantially constant at various locations along the longitudinal axis 312, while in certain other implementations, as schematically illustrated by FIGS. 3A and 3B, the width of the housing 310 differs at various locations along the longitudinal axis 312. The maximum width of the housing 310 can be equal to the sum of the first maximum distance Dₘₐₓ₁ and the second maximum distance Dₘₐₓ₂. FIG. 3A schematically illustrates a perimeter 314 with a generally monotonically varying width and FIG. 3B schematically illustrates a perimeter 314 with a generally non-monotonically varying width, and other shapes and/or dimensions are also compatible with certain implementations described herein.

In certain implementations, the actuator 320 comprises a vibrating electromagnetic actuator, a vibrating piezoelectric actuator, and/or another type of vibrating actuator, and the apparatus 300 is sometimes referred to herein as a vibrator unit. As schematically illustrated by FIGS. 3A and 3B, the actuator 320 can be substantially centered on the longitudinal axis 312. The actuator 320 is configured to respond to control signals (e.g., from a sound processor) by generating a mechanical output force in the form of acoustic vibrations that is delivered to the skull of the recipient (e.g., via an implantable component 206). In other words, the actuator 320 converts sound signals received by the apparatus 300 into mechanical motion to impart vibrations to the recipient's skull which are detected by the recipient's ossicles and/or cochlea and which evoke a hearing percept by the recipient.

In certain implementations, the actuator 320 comprises an unbalanced actuator that is configured to transmit the generated vibrations to the recipient's body via only a single surface of the second housing portion 310b, only the single surface configured to contact the recipient's skin 132 during operation of the apparatus 300. As used herein, the term “unbalanced actuator” is intended to distinguish from a balanced actuator which is configured to transmit vibrations to either of two opposite surfaces of the housing, both configured to be placed in contact the recipient's skin 132 during operation. An unbalanced actuator 320 can be cheaper to manufacture and can provide improved performance as compared to a balanced actuator.

In certain implementations, the apparatus 300 further comprises a microphone 330 and at least one processor 340 within the housing 310 and in operative communication with the microphone and the actuator 320. The microphone 330 (e.g., condenser microphone; capacitor microphone; electret microphone; dynamic microphone) of certain implementations is configured to detect sound (e.g., in a range of 20 Hz to 20 kHz) and can be small (e.g., having a generally cylindrical shape with a diameter of 1-3 millimeters). The microphone 330 can be configured to be worn on or within the housing 310 of the apparatus 300 or spaced from the housing 310 (e.g., with the housing 310 worn behind the pinna 105 and the microphone 330 within a recess 108 of the pinna 105 or spaced from the ear). In contrast to conventional hearing aids with a microphone on top or behind the ear, certain implementations described herein have the microphone 330 in the recess 108 and an actuator 320 behind the ear.

In certain implementations, the at least one processor 340 comprises a single processor (e.g., microelectronic circuitry; application-specific integrated circuit; generalized integrated circuits programmed by software with computer executable instructions; sound processor; digital signal processor; analog signal processor) in operative communication with the microphone 330 and the actuator 320. As schematically illustrated by FIGS. 3A and 3B, the at least one processor 340 can be substantially centered on the longitudinal axis 312 (e.g., within the same housing 310 as the actuator 320 which can also be substantially centered on the longitudinal axis 312). The at least one processor 340 can be configured to receive data signals indicative of audio data, to generate control signals in response to the data signals, and to transmit the control signals to the actuator 320. For example, the data signals can be generated by the microphone 330 and indicative of sounds detected by the microphone. For another example, the data signals can be generated by a remote broadcast system and/or a media player (e.g., smart phone, smart tablet, smart watch, radio, laptop computer, or other mobile computing device; television; desktop computer, or other non-mobile media player used, worn, held, and/or carried by the recipient) providing media content being watched and/or listened to by the recipient with the data signals transmitted to the at least one processor 340 wirelessly (e.g., WiFi; Bluetooth; cellphone connection, telephony, or other Internet connection). The actuator 320 can be configured to generate the vibrational signals in response to the control signals. In certain implementations, the apparatus 300 further comprises at least one user input device (e.g., button; switch; dial; voice recognition system; not shown in FIGS. 3A and 3B) on the housing 310 and configured to provide user control signals from the user (e.g., volume control; mode control; on/off control) to the at least one processor 340 of the apparatus 300.

In certain implementations, the at least one processor 340 comprises and/or is in operative communication with at least one storage device configured to store information (e.g., data; commands) accessed by the at least one processor 340 during operation (e.g., while providing the functionality of certain implementations described herein). The at least one storage device can comprise at least one tangible (e.g., non-transitory) computer readable storage medium, examples of which include but are not limited to: read only memory (ROM); random access memory (RAM); magnetic disk storage media; optical storage media; flash memory. The at least one storage device can be encoded with software (e.g., a computer program downloaded as an application) comprising computer executable instructions for instructing the at least one processor 340 (e.g., executable data access logic, evaluation logic, and/or information outputting logic). In certain implementations, the at least one processor 340 executes the instructions of the software to provide functionality as described herein.

In certain implementations, as schematically illustrated by FIGS. 3A and 3B, the apparatus 300 further comprises an elongate element 350 having a first end portion 352 in operative communication with the processor 340 and a second end portion 354 in operative communication with the microphone 330, the microphone 330 spaced from the housing 310. For example, the elongate element 350 can comprise rubber, plastic, and/or metal and can comprise at least one electrical conduit (e.g., two electrical current conduits and one electrical signal conduit) configured to provide electrical communication between the microphone 330 and the processor 340 (e.g., via a three-pin connector coupling the elongate element 350 with the housing 310). The elongate element 350 of certain implementations is configured to be bendable (e.g., repeatedly) to adjust the relative positions of the microphone 330 and the housing 310.

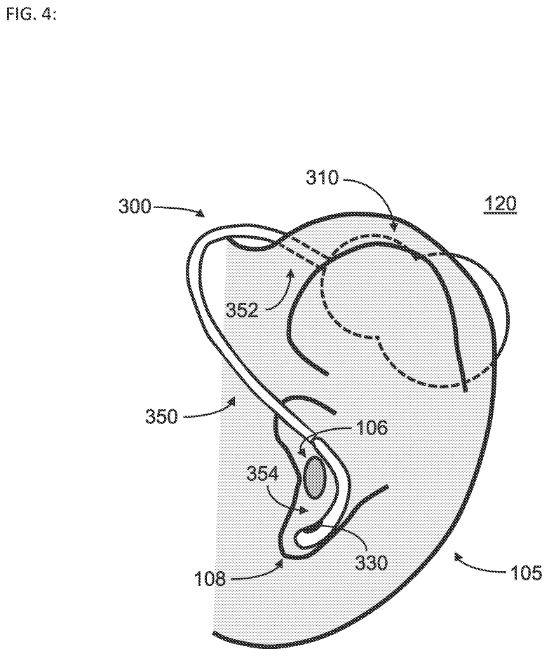

FIG. 4 schematically illustrates the example apparatus 300 of FIG. 3B at an example position on the left ear of the recipient's body in accordance with certain implementations described herein. As shown in FIG. 4, the housing 310 and the first end portion 352 of the elongate element 350 are configured to be positioned between the pinna 105 and the skull 120 and the second end portion 354 of the elongate element 350 is configured to be positioned within a recess 108 of the pinna 105 (e.g., outside the ear canal 106 or within the ear canal 106). In certain implementations, such separation of the actuator 320 and the microphone 330 (e.g., with the pinna 105 therebetween) can facilitate reduced acoustic feedback by screening vibrations from the actuator 320 from being detected by the microphone 330. The pinna 105 can serve as a natural wall that absorbs at least a portion of the vibrations (e.g., higher frequency vibrations in a range of 1 kHz to 20 kHz) generated by the actuator 320 from reaching the microphone 330.

In certain implementations, the elongate element 350 is configured to provide at least some mechanical support holding the apparatus 300 on the recipient's body. The elongate element 350 of certain implementations is sufficiently resilient such that when the apparatus 300 is in an operational position (see, e.g., FIG. 4), the elongate element 350 serves as a suspension hook abutting against the pinna 105 and supporting at least some of the weight of the apparatus 300 on the ear. For example, the elongate element 350 can provide a first retention force configured to contribute to holding the housing 310 such that the actuator 320 is operatively coupled to the recipient's skin 132 (e.g., the first retention force comprising a spring force pressing the housing 310 against the skin 132). In certain implementations, other forces also contribute to holding the housing 310 such that the actuator 320 is operatively coupled to the skin 132. For example, the apparatus 300 can comprise at least one permanent magnet configured to generate an attractive magnetic force with a ferromagnetic or ferrimagnetic element of an implantable component 206. For another example, the housing 310 can comprise an outer surface having a sticky, tacky, or adhesive material or coating configured to contact the recipient's skin and to form an adhesive force between the housing 310 and the skin 132.

The elongate element 350 of certain implementations is sufficiently resilient such that when the apparatus 300 is in an operational position (see, e.g., FIG. 4), the elongate element 350 provides a second retention force configured to contribute to holding the microphone 330 within the recess 108 of the recipient's pinna 105. By holding the microphone 330 within the recess 108 of the pinna 105 (e.g., in or in proximity of the ear canal 106), certain implementations utilize the sound focusing properties of the pinna 105 (e.g., the natural parabolic shape of the ear) to facilitate sound detection or uptake by the microphone 330 (e.g., more natural beamforming) and/or perception of sound direction by the recipient (e.g., directionality).

For example, the second end portion 354 of the elongate element 350 can be configured to be shaped (e.g., bent) so as to conform to the geometry of an inner surface of the recess 108. For another example, the second end portion 354 can comprise an outer surface having a sticky, tacky, or adhesive material or coating configured to contact the skin 132 within the recess 108 and to form an adhesive force between the second end portion 354 and the skin 132 within the recess 108. For another example, the second end portion 354 can comprise a molded earpiece containing the microphone 330 and configured to mate with the recess 108 and/or the ear canal 106. In certain such implementations, the earpiece can comprise an opening for ambient sound to enter the ear canal 106 (e.g., the molded earpiece does not occlude the ear canal 106; open ear mold). The earpiece can have a contoured shape formed from a cast of the recess 108 or can have a formable shape configured to assume a shape of the recess 108.

In certain implementations, the apparatus 300 is both left and right compatible (e.g., the apparatus 300 is configured to be used as a bone conduction device at either the left side or the right side of the recipient's skull 120). In certain implementations, the housing 310 has a single outer surface configured to be in contact with the recipient's skin 132 and the actuator 320 can be configured to transmit the vibrational signals to the recipient's body via the single outer surface of the housing 310 (e.g., an unbalanced actuator). For example, the actuator 320 can be configured to be either in mechanical communication with a first device implanted at a first side of the skull 120 with the single outer surface of the housing 310 facing the first side of the skull 120 or in mechanical communication with a second device implanted at a second side of the skull 120 with the single outer surface of the housing 310 facing a second side of the skull 120, the second side substantially opposite to the first side. In certain implementations in which the apparatus 300 comprises at least one permanent magnet configured to generate an attractive magnetic force with a ferromagnetic or ferrimagnetic portion of either the first device or the second device, the attractive magnetic force extends through the single outer surface.

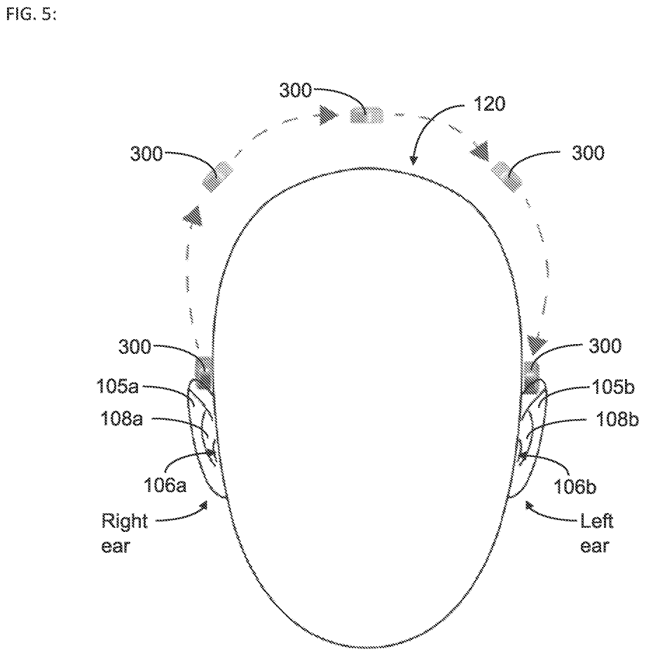

FIG. 5 schematically illustrates an apparatus 300 switched from being used at the right side of the recipient's skull 120 to being used at the left side of the recipient's skull 120 in accordance with certain implementations described herein. As shown in FIG. 5, the apparatus 300 can be switched from the right side to the left side (or vice versa) by removing the apparatus 300 from the skull 120 and rotating the apparatus 300 about the longitudinal axis 312, which in FIG. 5 extends perpendicularly to the page. By having the second maximum distance Dₘₐₓ₂ substantially equal to the first maximum distance Dₘₐₓ₁ (e.g., the longitudinal axis 312 is a symmetry axis of the housing 310), the apparatus 300 is configured to be located at equivalent positions on either the left side or the right side of the skull 120 (e.g., the shape of the housing 310 does not constrain locating the apparatus 300 at the two equivalent positions).

In certain implementations, the apparatus 300 is compatible for use by a bilateral recipient that uses two bone conduction devices (e.g., two devices 100; two devices 200) concurrently at substantially opposite sides of the recipient's skull 120. For example, the recipient can use the same apparatus 300 at the left side of the skull 120 at certain times and at the right side of the skull 120 at certain other times. In other words, the bilateral recipient can use two apparatus 300 in accordance with certain implementations described herein without keeping track of which apparatus 300 is to be used on the left side and which apparatus 300 is to be used on the right side.

In certain implementations, the elongate element 350 is configured to facilitate the apparatus 300 being used alternatively either at the right or left side of the skull 120. For example, the elongate element 350 can be configured to be rotatably coupled to the housing 310 such that the elongate element 350 can be rotated 180 degrees about the longitudinal axis 312 to be selectively configured for use on either the left side or the right side of the skull 120. For another example, the elongate element 350 is configured for use on a single side of the skull 120 (e.g., the left side; the right side) and to be detached from the housing 310 (e.g., without damage to the housing 310 or the elongate element 350) and replaced by a different elongate element 350 configured for use on the other side of the skull 120 (e.g., the right side; the left side).

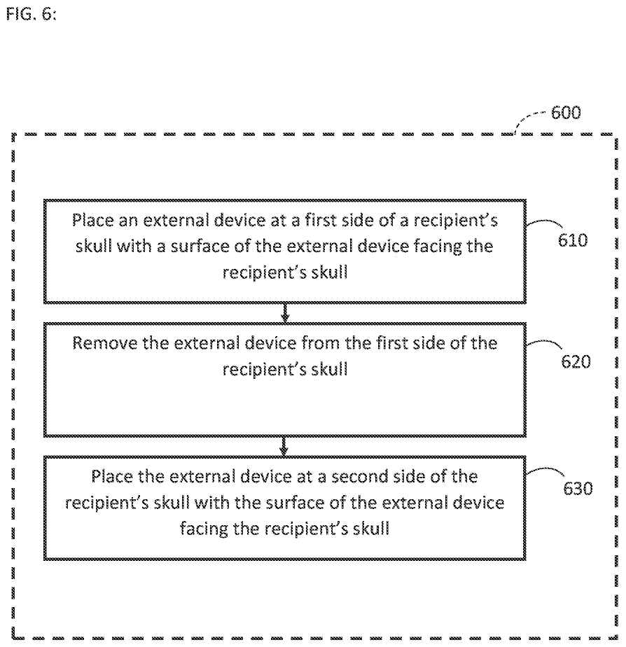

FIG. 6 is a flow diagram of an example method 600 in accordance with certain implementations described herein. While the method 600 is described by referring to some of the structures of the example apparatus 300 of FIGS. 3A-3B, 4, and 5, other apparatus and systems with other configurations of components can also be used to perform the method 600 in accordance with certain implementations described herein.

In an operational block 610, the method 600 comprises placing an external device (e.g., apparatus 300) at a first side of a recipient's skull 120 with a surface of the external device facing the recipient's skull 120. In certain implementations, said placing the external device at the first side of the recipient's skull 120 comprises positioning the external device such that the external device is in operative communication with a first implanted auditory prosthesis (e.g., first implantable component 206) at the first side of the recipient's skull 120.

In an operational block 620, the method 600 further comprises removing the external device from the first side of the recipient's skull 120.

In an operational block 630, the method 600 further comprises placing the external device at a second side of the recipient's skull 120 with the surface of the external device facing the recipient's skull 120. In certain implementations, said placing the external device at the second side of the recipient's skull 120 comprises positioning the external device such that the external device is in operative communication with a second implanted auditory prosthesis (e.g., second implantable component 206) at the second side of the recipient's skull 120, the second side substantially opposite to the first side.

In certain implementations in which a housing 310 of the external device comprises the surface and the external device comprises an elongate signal conduit (e.g., elongate element 350) extending from the housing 310 to a microphone 330 spaced from the housing 310, said placing the external device on the first side of the recipient's skull 120 in the operational block 610 comprises placing the microphone 330 in a first recess 108a of a first ear (e.g., pinna 105a) of the recipient, and said placing the external device on a second side of the recipient's skull 120 in the operational block 630 comprises placing the microphone 330 in a second recess 108b of a second ear (e.g., pinna 105b) of the recipient, the second ear different from the first ear. For example, the first recess 108a can be outside an ear canal 106a of the first ear and the second recess 108b is outside an ear canal 106b of the second ear.

In certain implementations, said placing the external device on the second side of the recipient's skull 120 comprises bending or rotating the elongate signal conduit relative to the housing 310, while in certain other implementations, said placing the external device on the second side of the recipient's skull 120 comprises detaching the elongate signal conduit from the housing 310 and attaching a different elongate signal conduit to the housing 310.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of various devices, various implementations described herein can be incorporated in a variety of other suitable devices, methods, and contexts. More generally, as can be appreciated, certain implementations described herein can be used in a variety of implantable medical device contexts that can benefit from certain attributes described herein.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein but should be defined only in accordance with the claims and their equivalents.

1. An apparatus comprising:
an elongate housing having a longitudinal axis and a perimeter, the housing configured to be positioned on and substantially parallel to a skin surface of a recipient's body with the longitudinal axis and the perimeter extending along the skin surface, the perimeter extending a first maximum distance from the longitudinal axis in a first direction substantially perpendicular to the longitudinal axis, the perimeter extending a second maximum distance from the longitudinal axis in a second direction opposite to the first direction, the second maximum distance substantially equal to the first maximum distance; and
an actuator within the housing, the actuator configured to generate vibrational signals and to transmit the vibrational signals to the recipient's body.

2. The apparatus of claim 1, wherein the housing is substantially planar and the longitudinal axis is a symmetry axis of the perimeter.

3. The apparatus of claim 1 further comprising:
a microphone; and
a processor within the housing and in operative communication with the microphone and the actuator, the processor configured to receive data signals from the microphone, to generate control signals in response to the data signals, and to transmit the control signals to the actuator, the actuator configured to generate the vibrational signals in response to the control signals.

4. The apparatus of claim 3, further comprising an elongate element having a first end portion in operative communication with the processor and a second end portion in operative communication with the microphone, the microphone spaced from the housing.

5. The apparatus of claim 4, wherein the elongate element comprises at least one electrical signal conduit configured to provide electrical communication between the microphone and the processor.

6. The apparatus of claim 4, wherein the second end portion of the elongate element is configured to be positioned within a recess of the recipient's pinna and outside the recipient's ear canal.

7. The apparatus of claim 6, wherein the first end portion of the elongate element and the housing are configured to be positioned between the recipient's pinna and the recipient's skull.

8. The apparatus of claim 4, wherein the elongate element is configured to provide at least some mechanical support holding the apparatus on the recipient's body.

9. The apparatus of claim 1, wherein the actuator is configured to be at a first side of the recipient's skull with a single outer surface of the housing facing the first side of the recipient's skull or at a second side of the recipient's skull with the single outer surface of the housing facing a second side of the recipient's skull, the second side substantially opposite to the first side.

10. The apparatus of claim 1, wherein the actuator is configured to be either in mechanical communication with a first device implanted at a first side of the recipient's skull or in mechanical communication with a second device implanted at a second side of the recipient's skull.

11. The apparatus of claim 10, wherein the actuator further comprises at least one permanent magnet configured to generate an attractive magnetic force with a ferromagnetic or ferrimagnetic portion of either the first device or the second device, the attractive magnetic force extending through the single outer surface.

12. The apparatus of claim 1, wherein the actuator comprises an electromagnetic actuator and/or a piezoelectric actuator.

13. The apparatus of claim 1, wherein the vibrational signals evoke a hearing percept by the recipient.

14. A method comprising:
placing an external device at a first side of a recipient's skull with a surface of the external device facing the recipient's skull;
removing the external device from the first side of the recipient's skull; and
placing the external device at a second side of the recipient's skull with the surface of the external device facing the recipient's skull, the second side substantially opposite to the first side.

15. The method of claim 14, wherein said placing the external device at the first side of the recipient's skull comprises positioning the external device such that the external device is in operative communication with a first implanted auditory prosthesis at the first side of the recipient's skull, and said placing the external device at the second side of the recipient's skull comprises positioning the external device such that the external device is in operative communication with a second implanted auditory prosthesis at the second side of the recipient's skull.

16. The method of claim 14, wherein a housing of the external device comprises the surface and the external device comprises an elongate signal conduit extending from the housing to a microphone spaced from the housing, said placing the external device on the first side of the recipient's skull comprising placing the microphone in a first recess of a first ear of the recipient, and said placing the external device on a second side of the recipient's skull comprises placing the microphone in a second recess of a second ear of the recipient, the second ear different from the first ear.

17. The method of claim 16, wherein the first recess is outside an ear canal of the first ear and the second recess is outside an ear canal of the second ear.

18. The method of claim 14, wherein said placing the external device on the second side of the recipient's skull comprises bending or rotating the elongate signal conduit relative to the housing.

19. The method of claim 14, wherein said placing the external device on the second side of the recipient's skull comprises detaching the elongate signal conduit from the housing and attaching a different elongate signal conduit to the housing.

20. An apparatus comprising:
a housing configured to be positioned between an ear and a skull of a recipient;
an actuator within the housing, the actuator configured to generate vibrational signals and to transmit the vibrational signals to the skull;
an elongate signal conduit in operative communication with and extending from the housing; and
a microphone in operative communication with a portion of the conduit spaced from the housing, the microphone configured to be positioned within a recess of a pinna of the ear.

21. The apparatus of claim 20, wherein the microphone is configured to be positioned outside an ear canal of the ear.

22. The apparatus of claim 20, wherein the conduit further comprises a molded earpiece containing the microphone and configured to mate with the recess and/or the ear canal.

23. The apparatus of claim 22, wherein the earpiece comprises an opening for ambient sound to enter the ear canal.
